(19) United States
(12) Patent Application Publication
(10) Pub. No.: US 2006/0115105 A1
(43) Pub. Date: Jun. 1, 2006

(54) Acoustically tailored hearing aid and method of manufacture

(75) Inventors: Mark A. Brumback, Plano, TX (US); Dustin L. Potter, Sugar Land, TX (US)

Correspondence Address: ANDREWS & KURTH, L.L.P., 600 TRAVIS, SUITE 4200, HOUSTON, TX, 77002, US

(73) Assignee: SYNYGIS, LLC

(21) Appl. No.: 11/292,186

(22) Filed: Nov. 30, 2005

Related U.S. Application Data
(60) Provisional application No. 60/632,404, filed on Dec. 1, 2004.

(51) Int. Cl. H04R 25/00

(52) U.S. Cl. 381/328; 381/322; 381/325

(57) ABSTRACT

An apparatus and method for tailoring the audio frequency response of a hearing aid or other ear piece by altering the physical characteristics of the device to more accurately compensate for a user's specific hearing loss attributes. The device has a bore formed within its ear piece shell which provides a passage for the transmission of sound from the speaker or receiver of the device toward the user's eardrum. The bore has a custom-designed shape to emphasize desired sound frequencies and therefore produce a predetermined frequency response of sound in combination with any frequency response changes of the device's circuitry.

### CROSS REFERENCE TO RELATED APPLICATION

This application is based upon provisional application 60/632,404 filed on Dec. 1, 2004, the priority of which is claimed.

### BACKGROUND OF THE INVENTION

1. Field of the Invention

This invention relates to custom designed hearing instruments and other ear devices and methods for making them. Such hearing instruments include devices commonly called hearing aids. Other ear devices include, for example, musician's custom ear monitors and custom fit ear pieces for personal communication devices such as cell phones, PDAs, digital audio playback devices for music or portable audio/video equipment and custom fit language translators. More specifically, this invention relates to tailoring the physical characteristics of a hearing instrument to produce desired sound frequency responses.

2. Description of the Prior Art

FIG. 1 shows a typical prior art hearing aid with an external size and shape custom manufactured to fit a specific wearer's ear. The outer face (12) of the ear piece (10) generally includes a microphone (14), an adjustment knob (16) or other means to turn on and off the device and to adjust the output volume, and an access cover (18) for battery replacement. The ear piece (10) includes an outer shell (20) which is generally formed to fit comfortably within a user's ear canal. The ear piece (10) generally has a slender portion which is referred to as the canal (22), so named because of its intended placement within the wearer's outer ear canal.

These custom-fit ear pieces are generally manufactured at a central manufacturing facility. The three-dimensional shape of a user's ear canal can be obtained by first taking a direct silicone impression of the ear and then obtaining scanning data thereof by scanning that impression with a three-dimensional digitizing device. Alternatively, scanning data can be obtained by probing the ear with a three-dimensional probe scanner. The scanning data is usually input into a computer which uses three-dimensional design or modeling software to mathematically model the impression into the shape of the desired instrument, ear mold, or other ear device. Next, the mathematical model is transmitted to the manufacturing facility where it is used to produce an actual hearing aid shell or other device for client application.

FIG. 2 shows the prior art custom ear piece (10) of FIG. 1 with a portion of the outer shell (20) cut away to reveal the internal components as they are typically arranged. The ear piece (10) has miniaturized electronic circuitry (24) which amplifies sounds received at the microphone (14). The circuitry (24) is operatively coupled to a volume control knob (16) (if applicable) to allow the user to control the amplification. The circuitry (24) may include one or more integrated circuits (26) and a battery (28). The output of the amplification circuitry (24) drives a speaker element, which in the industry is often referred to (and referred to herein) as a receiver (30). Using current production techniques, the receiver (30) is typically attached by hand to one end of a standardized piece of tubing (32). The other end of the tubing (32) is attached by hand to the tip (34) of the canal (22) of the custom-manufactured ear piece (10). The tip or tip end (34) of the ear piece 10 faces the ear drum when placed in a wearer's ear canal. Sound is transmitted from the receiver (30) via the tubing (32) to the wearer's eardrum.

When custom hearing instruments or ear molds are produced, certain features of the instruments are standardized to better accommodate the capabilities of the assembly line process in the hearing instrument or ear mold production facility. For example, vent channels through the ear piece are intended to promote wearer comfort. The smallest vent, called a pressure vent, promotes wearer comfort by allowing air to enter the ear canal thereby maintaining atmospheric pressure in the ear canal while the ear piece is in place. Large vents, however, have an effect on the acoustic response of the device. A pressure vent has little effect on acoustic response. But vents with larger diameters reduce some of the low frequency sounds amplified by the hearing aid by providing an alternative path of lesser acoustic resistance. Larger vents also mitigate the occlusion effect caused by an ear piece that completely fills the outer portion of the ear canal. The occlusion effect occurs when bone-conducted sound vibrations from a speaker's own voice become trapped between the ear piece and the ear drum thus producing what is perceived by the speaker to be a “hollow” or “booming” sounding voice. Some hearing instrument manufacturers provide for venting of the shell, but the venting is generally limited to a few standard sizes because of geometric challenges and manufacturing inefficiencies.

Rather than tailoring the physical characteristics of the hearing device to emphasize desired frequencies, the prior art is generally concerned with electronically “tuning” the hearing device using the amplification circuitry. Generally, an audiometric evaluation is conducted to determine the user's hearing response at various frequencies, usually plotted as amplitude versus frequency. This information is used to select an amplification circuit from a number of standardized circuits and/or to adjust the frequency response of the chosen electronic amplification circuit in order to boost the amplification at those frequencies where the user is the most hard of hearing.

The prior art includes hearing aids with an “ear hook” having an amplifier and receiver worn on the outside of a user's ear and an ear mold worn in the user's ear canal. Tubing conducts sound from the receiver on the ear hook to a bore in the ear mold for transmission to the user's eardrum. The ear hook amplifier typically included a wideband frequency response. A 1981 paper published in the Journal of Speech and Hearing Disorder titled, “Earmold Options for Wideband Hearing Aides” by Mead C. Killian describes how this tubing of various sizes and geometries within the bore or sound channel of the ear mold can be selected to affect the high frequency response of the hearing aid.

Advances in hearing aid design have produced miniature housings which can be placed inside the ear rather than on the outside of the ear or with prior ear hook housings. In other words, housings within an integrated canal portion take the place of the prior ear hook housing and ear mold connected by tubing. New arrangements and methods for preselecting the frequency response in the ear hearing instrument are desired.

3. Identification of Objects of the Invention

A general object of this invention is to provide a method and apparatus for tailoring the audio frequency response of an in the ear hearing instrument by altering the physical characteristics of the device to more accurately compensate for a user's specific hearing loss attributes.

Another object of the invention is to provide an improved in the ear hearing aid or other ear piece in which a passage of cylindrical shape between the receiver in the device and the outlet of the device is replaced in part by a passage of non-cylindrical shape in order to alter the sound frequency of the instrument.

Another object of the invention is to provide an improved in the ear shell or other ear piece in which a cylindrical tube is connected between a receiver in the shell and a passage of conical shape to emphasize desired frequency ranges.

Another object of the invention is to provide a method of producing an improved in the ear hearing aid shell in which the passage between the receiver of the device and the outlet of the device is part of a non-cylindrical shape and where the non-cylindrical shape and the shell are formed by rapid prototyping.

### SUMMARY OF THE INVENTION

The objects identified above are incorporated in an ear piece having a hollow shell with a canal portion custom-manufactured to fit in a user's ear canal using three-dimensional topological ear canal measurements, computer-aided design and modeling, and/or rapid prototype manufacturing. At the tip of the ear canal portion, a bore is formed which extends inwardly toward the receiver (speaker) of the ear piece. The bore has an outlet at the tip of the ear canal portion and an inlet. A coupler, such as a gasket or receiver tube, connects and seals the receiver of the ear piece to the inlet of the bore. The bore provides a passage for the transmission of sound from the receiver to the user's eardrum. The bore has a custom-designed shape, for example, a cone, to emphasize desired frequencies. A cone with an acute graduation away from the receiver results in emphasis of frequencies above 8000 Hz, whereas a cone with an obtuse graduation away from the receiver can result in the emphasis of lower frequency sound. The desired bore geometry is included in a mathematical model of the ear piece shell, and the bore is formed concurrently with the shell using a rapid prototyping process.

### BRIEF DESCRIPTION OF THE DRAWINGS

The invention is described in detail below on the basis of the preferred embodiments represented in the accompanying figures, in which:

FIG. 1 is a perspective drawing which illustrates a prior art hearing aid device having a shell with an external size and shape custom fit for a particular user;

FIG. 2 is a perspective drawing of the prior art hearing device of FIG. 1 with a portion of the external shell cut away to reveal the internal construction of the device;

FIG. 3 is a perspective drawing of a hearing aid according to an embodiment of the invention designed and arranged to emphasize high frequency audio signals with a portion of the device cut away to reveal the internal construction and an acute cone-shaped receiver bore;

FIG. 4 is a perspective drawing of a hearing aid device according to an embodiment of the invention designed and arranged to emphasize low frequency audio signals with a portion of the device cut away to reveal the internal construction and an obtuse cone-shaped receiver bore;

FIG. 5A is a perspective drawing which illustrates an internal construction of a hearing aid according to an embodiment of the invention having a receiver tube coupler which couples to a receiver bore with a variable diameter between the bore inlet and bore outlet;

FIG. 5B is a perspective drawing which illustrates an internal construction of a hearing aid according to an embodiment of the invention having a gasket coupler which couples to a receiver bore with a variable diameter between the bore inlet and bore outlet;

FIG. 6 is a perspective drawing which provides a posterior view of a hearing aid according to an embodiment of the invention having an obtuse cone-shaped receiver bore;

FIG. 7 is a perspective drawing which illustrates an acute cone-shaped receiver bore and internal construction of a hearing aid according to an embodiment of the invention designed and arranged to emphasize high frequency audio signals; and

FIG. 8 is a perspective drawing which illustrates an obtuse cone-shaped receiver bore and internal construction of a hearing aid according to an embodiment of the invention designed and arranged to emphasize low frequency audio signals.

### DESCRIPTION OF A PREFERRED EMBODIMENT OF THE INVENTION

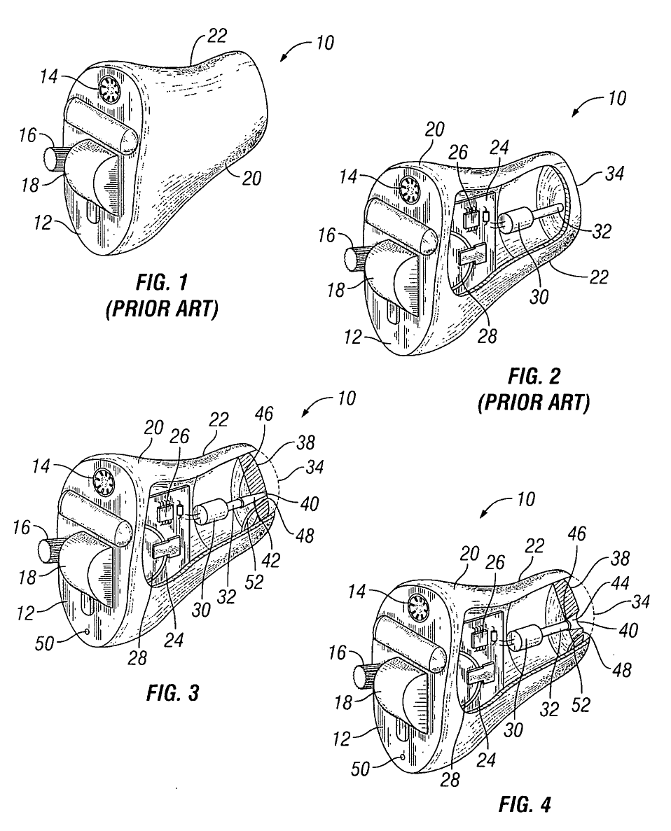

FIG. 3 shows a partial cross-sectional view of a custom-manufactured hearing aid (10′) according to one embodiment of the invention having an acute cone-shaped receiver bore (40). Hearing aid (10′) is similar to hearing aid (10) of FIGS. 1-2, including a custom-manufactured shell (20), electronic circuitry (24), microphone (14), receiver (30), adjustment knob (16) or equivalent, battery (28), et cetera. However, unlike the prior art hearing aid (10) of FIG. 2, the hand-fitted receiver tube (32) within the hollow shell (20), which audibly couples the receiver (30) to the shell (20) at the tip (34) of the canal (22), is truncated. In a preferred embodiment of the invention, the hand-fitted receiver tube (32) connects to the tubing seat (46) of a bore (40), which is formed in the canal shell (38) between the receiver (30) and the tip (34). Thus, the hand-fitted receiver tube (32) is a coupler that audibly connects the receiver (30) to the bore (40). The hand-fitted receiver tube (32) is seated in the tubing seat (46) of the bore (40) and sealed with an adhesive, such as ethyl cyanoacrylate, to prevent audio feedback. Alternative couplers, such as gaskets (54), adhesives, chemical sealants, et cetera, can be used to connect and seal the receiver (30) to the bore (40). The shell (20) and the canal shell (38) (with bore (40)) are preferably integrally produced in the same manufacturing process. The receiver tube (32) may be fitted to the tubing seat (46) of the bore (40) after the shell (20) and integral canal shell (38) (with bore (40)) are formed.

In a preferred embodiment of the invention, a vent channel (52) is located along the interior of the ear piece shell (22) from an external vent opening (50) at the outer face (12) of the ear piece to an internal vent opening (48) at the canal shell (38). Vent channels through the ear piece are intended to promote wearer comfort by allowing air to enter the ear canal thereby maintaining atmospheric pressure in the ear canal while the ear piece is in place. The vent channel (52) is preferably a tube which is integrally produced within the shell (20) and the canal shell (38) (with bore (40)) in the same manufacturing process. However, the vent channel (52) can also be a non-integrated separate tube located within the shell (20) and extending from the external vent opening (50) to the internal vent opening (48).

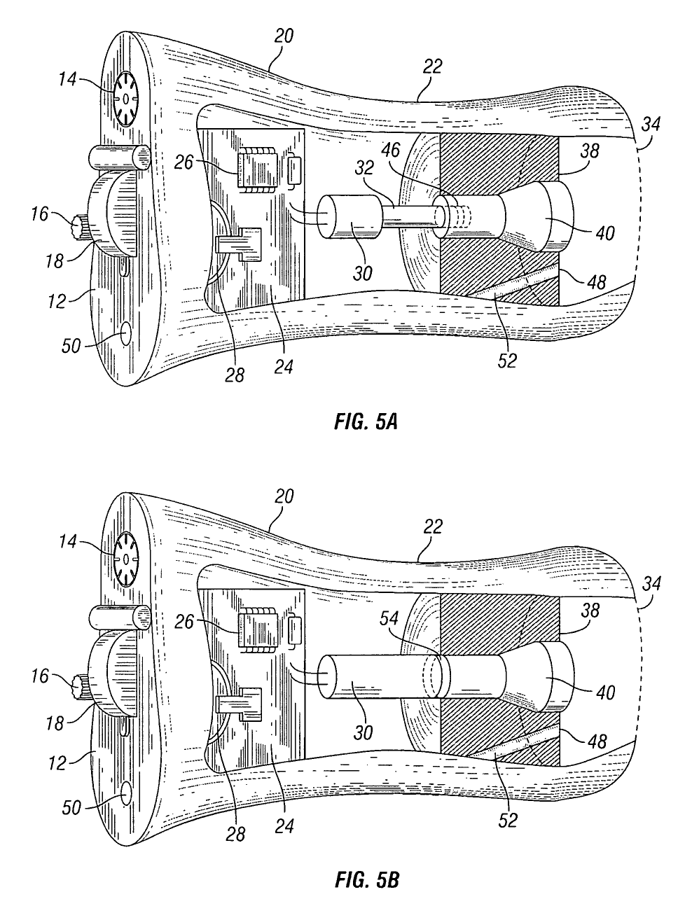

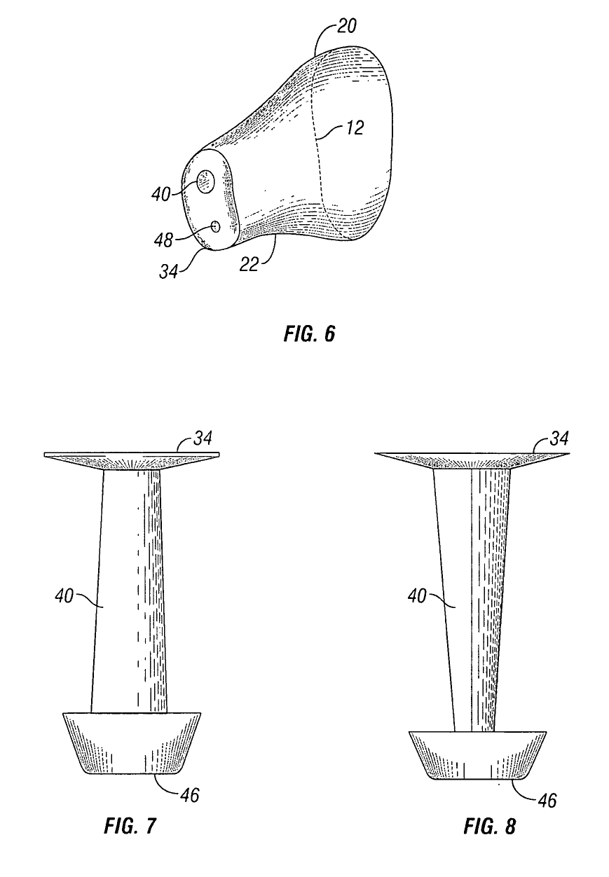

Bore (40) is preferably formed with a geometry having selected dimensions to enhance desired audio frequencies. For example, as shown in FIG. 3, bore (40) is shaped as a cone (42) with an acute graduation, i.e. a narrow cone. The cone (42) is oriented with its base at the end of the receiver tube (32) and its tip at the canal tip (34) of the hearing instrument (10′). A cone (42) with an acute graduation coming from the tip of the receiver tube (32) results in greater emphasis of frequencies above 8000 Hz. FIG. 4 illustrates a hearing aid (10″) according to an embodiment of the invention with bore (40) designed and arranged to emphasize lower frequencies. Bore (40) has the shape of a cone (44) with a more obtuse graduation, i.e., a wide cone. FIGS. 5A and 5B illustrate an embodiment of the invention having a bore (40) with varying diameters between the bore inlet and outlet designed and arranged to produce a predetermined audio frequency response. FIG. 5A illustrates an embodiment of the invention having a receiver tube coupler (32) which couples the receiver (30) to the bore (40). FIG. 5B illustrates an embodiment of the invention having a gasket coupler (54) which couples the receiver (30) to the bore (40).

The design of bore (40) is dependent on a number of factors, including the desired frequency response, the available length of canal (22) between receiver (30) and tip (34), and the acoustic qualities of the canal shell (38) material. The effects of bore geometry on frequency response can be determined mathematically and are preferably modeled by computer program. Alternatively, bore geometry effects may be empirically determined based on testing a number of varying bore designs and dimensions. Specifically, the frequency response of a hearing instrument is dependant to varying degrees upon three physical variables: the bore length, bore angle, and coupler length. The length of the receiver tube or coupler (32) between the receiver (30) and the bore tube seating (46) has a significant affect on the frequency response of the hearing instrument. In some cases, a 0.25 inch increase in tubing length can cause a 400% increase in acoustic benefit. Significant effects on the frequency response have been observed with coupler lengths approaching zero inches (i.e., only enough coupler length to couple the receiver (30) to the bore tube seating (46)) to as much as 0.56 inches (i.e. a coupler length limited by normal human anatomy). Direct coupling of the receiver (30) to the bore (40) may, in some cases, be beneficial.

The angle of the receiver bore (40) also has a significant effect on the audio frequency response. Different bore shapes, i.e. cones, inverted cones, et cetera, have different effects on the frequency response of the hearing instrument. The length of the actual bore (40) between the coupler (32) and the tip (34) is also a factor in bore effectiveness. Just as with coupler length, a longer bore length causes a greater effect on frequency response. Unfortunately, coupler length and bore length are limited by normal human anatomy. However, producing a bore and/or coupler with a spiral shape is one technique for increasing bore or coupler length without increasing the physical length of the ear piece. Table 1 gives a summary of observed frequency responses (i.e. sound pressure level shifts) produced using various configurations of bore length, bore angle, and coupler length.

TABLE 1
Receiver Bore Variations and Effect on Frequency Response

| | Tube | Bore | Bore | SPLS | SPLS | SPLS | SPLS | SPLS |
|---|---|---|---|---|---|---|---|---|
| Bore # | Length | Degree | Length | .5 KHz | 1 KHz | 2 KHz | 3 KHz | 4 KHz |
| Ref #1 | .5″ | n/a | n/a | 0 | 0 | 0 | 0 | 0 |
| 2 | ˜0″ | 0 | .30″ | 1 | 1 | 1.5 | 5 | 0 |
| 3 | ˜0″ | −8° | .54″ | 1 | 1 | 0 | 2 | 2 |
| 4 | ˜0″ | −8° | .42″ | 1 | 1 | 1 | 5 | 2 |
| 5 | ˜0″ | 0°/8°/24° | .29″ | 1 | 1 | 1 | 1 | 1 |
| 6 | ˜0″ | 8° | .35″ | 1 | 1 | 0 | 0 | 1 |
| 7 | ˜0″ | 24° | .59″ | 1 | 1 | 1 | 0 | 0 |
| 8 | ˜0″ | 8°/24° | .59″ | 1 | 1 | 1 | 0 | 0 |
| 9 | ˜0″ | 8°/24° | .84″ | 1 | 1 | 2 | 0 | 0 |
| 2T | .25″ | 0 | .30″ | 0 | 0 | 0 | 1 | 0 |
| 3T | .25″ | −8° | .54″ | 1 | 1 | 3 | 0 | 6 |
| 4T | .25″ | −8° | .42″ | 2 | 2 | 1 | 2 | 3 |
| 5T | .25″ | 0°/8°/24° | .29″ | 2 | 2 | 3 | 1 | 0 |
| 6T | .25″ | 8° | .35″ | 1 | 2 | 2 | 0 | 0 |
| 7T | .25″ | 24° | .59″ | 1 | 2 | 4 | 2 | 2 |
| 8T | .25″ | 8°/24° | .59″ | 2 | 2 | 3 | 2 | 0 |
| 9T | .25″ | 8°/24° | .84″ | 0 | 1 | 4 | 2 | 3 |

SPLS = Sound Pressure Level Shift in db SPL @ specified frequency

The overall frequency response of a hearing instrument is the product of the frequency response created by the hearing instrument circuitry (i.e., amplification, etc.) and the frequency response created by the physical characteristics of the sound passageway (i.e., bore length, etc.) through the hearing instrument. Thus, the overall frequency response of a hearing instrument can be tailored to correct for a user's hearing loss by changes to: its electronic circuitry, the physical characteristics of the acoustic passageways or a combination of both. Heretofore, adjusting the in-the-ear hearing instrument electronic circuitry has been the primary method of emphasizing desired audio sound frequencies. A preferred embodiment of the present invention is to arrange and design the physical characteristics of an in-the-ear hearing instrument's acoustic passageways in combination with adjustments to its electronic circuitry to produce a predetermined overall frequency response.

Creating an in-the-ear hearing aid (10′), (10″) with a canal shell (38) and custom-shaped bore (40) is not economically feasible when hearing aids are hand made, because the angle of the bore (40) at the receiver tube (32) must be managed with the utmost precision, and an opening in the canal shell (38) perfectly sized to fit the receiver tip is difficult to reliably produce by hand. However, with the advent of Rapid Prototyping Technology, also referred to as Rapid Manufacturing Technology, geometric limitations are greatly reduced. Each hearing aid shell (20) can now easily be manufactured not only with the comfort of the wearer in mind (i.e. with a vent channel integrally formed therein), but also with a canal shell (38) and bore (40) shaped to produce the desired acoustic response. The in-the-ear ear piece (10′), (10″) is designed mathematically using a computer, so great precision can be achieved with respect to the angle, shape, and frequency response of a certain receiver bore (40).

Rapid Manufacturing, also known as Rapid Prototyping, encompasses many different technologies, all having in common the principle of additive or subtractive creation of tangible three-dimensional parts from data provided either by computer model or direct duplication. A more complete listing of these technologies is available in Terry Wohlers' Wohlers Report 2003, but the major methods are described briefly in the following paragraphs.

Selective Laser Sintering is based upon the principle of applying laser energy to a powderous material in order to fuse the material at the point of contact with the laser. The laser traces a cross sectional slice of the object to be created thereby causing a cross sectional layer of the object desired to be created. After completion of the first layer, more powderous material is placed atop the fused layers, and the next cross sectional layer is created in the same manner. The process is repeated until the fully developed part is formed.

Stereolithography is similar to Selective Laser Sintering, but rather than fusing powder to form objects, this process entails solidifying a photosensitive resin with laser energy. The laser traces the outline of the object thereby creating a solidified cross section of a part of the object to be created. After the section is created, the layer is lowered into the resin, and the step is repeated. The process continues until the desired object is completed.

Fused Deposition Modeling and other similar processes, such as the Thermojet Technique, include the steps of depositing a cross sectional layer of thermoplastic or photosensitive plastic material, solidifying the layer by means of either temperature regulation or light exposure, and then laying then next layer upon the first. The process is repeated until the desired object is produced.

Laminated Object Manufacturing is the process of cutting sheets of plastic or paper with a laser, cutting tool, or heat source, cross sectional layer by cross sectional layer, and fusing the sheets together at the point at which they are sliced to produce the desired object.

The Drop on Powder Method includes the steps of depositing a binding agent upon a powderous material and binding it together to create a cross sectional layer of the object to be produced. An additional layer of the powderous material is then laid upon the first layer and that layer is bound together. The process is repeated until the desired object is formed.

The Visible Light Masking Method is a preferred method of producing ear shells, and entails projecting an image of a cross section of the object or objects to be created upon a photo sensitive resin or liquid photopolymer. The visible light cures the layer at the point of projection, and then the solidified layer is separated from the point of projection which allows more photosensitive resin to fill in where the cured layer was previously located. Next, the light is again projected thereby solidifying the second layer. The process is repeated until the desired object is formed.

A method of producing an ear piece (10′), (10″) with physically-tailored frequency response characteristics includes first conducting a full audiometric evaluation of the user. A hearing screening test is performed to determine air and bone conduction thresholds at critical frequencies. The complete audiometric evaluation produces an amplitude versus frequency response representative of the patient's hearing. Such information is used to select the proper amplification circuitry (24), design the bore (40) to emphasize certain frequencies, and program the amplification circuit (24) of the tailored hearing aid device in order to create an overall frequency response which compensates for any patient hearing deficiencies.

Next, an ear impression is taken. The ear/ear canal may be taken by a physical impression of the ear canal or a direct three-dimensional scan. For example, the three-dimensional shape of a user's ear canal can be remotely obtained by either scanning an impression of the ear with a white light scanner or a laser or other three-dimensional digitizing device, or by probing the ear with a type of three-dimensional probe. The ear canal topological information is used by computer-aided design software to create a three-dimensional mathematical model for the exterior surface of the ear piece shell (20). The three-dimensional mathematical model is then modified to include a canal shell (38) with custom-designed bore (40) and a socket or tube seating (46) to accommodate receiver tube (32). This modified model is then used to create a physical shell (20)/canal shell (38) with bore (40) ear piece (10′), (10″) by using one of the rapid prototyping methods described above. The Visible Light Masking Method, which uses a machine manufactured by Envisiontec, GmbH of Germany, is currently preferred. Finally, a receiver (30), a receiver tube (32) and a circuit (24) are assembled into the shell (20), and the hearing aid device is completed, inspected, and programmed for the client.

While the preferred embodiment of the invention has been illustrated in detail, it is apparent that modifications and adaptations of the preferred embodiment will occur to those skilled in the art. Such modifications and adaptations are in the spirit and scope of the invention as set forth in the following claims:

What is claimed is:

1. A hearing aid arrangement comprising,
a housing arranged and designed for insertion in an ear canal, said housing having a tip adapted to face an ear drum when said housing is inserted into said ear canal;
a receiver carried within said housing and spaced inwardly from said tip;
a bore formed in said housing and positioned between said receiver and said tip, said bore having an outlet at said tip and an inlet,
a coupler disposed between said receiver and said inlet, whereby a sound path is created from said receiver via said coupler and said bore toward said ear drum.

2. The arrangement of claim 1 wherein,
said bore has an inlet diameter and a tip diameter and is characterized by varying diameters between said inlet and said tip, said bore diameter selected to produce a predetermined frequency response of sound passing between said receiver and said tip.

3. The arrangement of claim 2 wherein,
the inlet diameter is greater than the tip diameter.

4. The arrangement of claim 2 wherein,
the inlet diameter is less than the tip diameter.

5. The arrangement of claim 1 wherein,
said bore has a length between said inlet and said tip which is selected to produce a predetermined frequency response of sound passing between said receiver and said tip.

6. The arrangement of claim 1 wherein,
said coupler is characterized by a geometry which is selected to produce a predetermined frequency response of sound passing between said receiver and said tip.

7. The arrangement of claim 1 wherein,
said coupler includes a gasket which couples said receiver to said inlet of said bore.

8. The arrangement of claim 1 wherein,
said coupler includes a tube disposed between said receiver and said inlet of said bore.

9. The arrangement of claim 1 further comprising
a vent channel disposed within said housing, said vent channel having a vent opening at said tip.

10. The arrangement of claim 1 wherein,
said housing with said bore is formed by a rapid prototyping process.

11. A hearing aid arrangement comprising,
an ear piece shell arranged and designed for insertion in an ear canal, said shell having a tip end adapted to face an ear drum when said shell is inserted into said ear canal, said shell having a bore formed therein at said tip end which extends inwardly from said tip end, said bore having an outlet at said tip end and an inlet, said shell with said bore formed therein by a rapid prototyping process;
a receiver carried within said ear piece shell; and
a coupler disposed between said receiver and said inlet, whereby a sound path is created from said receiver via said coupler and said bore toward said ear drum.

12. The arrangement of claim 11 wherein,
said bore has varying diameters between said inlet and said tip end, said varying diameters selected to produce a predetermined frequency response of sound passing between said receiver and said tip end.

13. The arrangement of claim 11 wherein,
said bore has a length between said inlet and said tip end which is selected to produce a predetermined frequency response of sound passing between said receiver and said tip end.

14. The arrangement of claim 11 wherein,
said coupler is characterized by a geometry selected to produce a predetermined frequency response of sound passing between said receiver and said tip end.

15. The arrangement of claim 11 wherein,
said coupler includes a gasket which couples said receiver to said inlet of said bore.

16. The arrangement of claim 11 wherein,
said coupler includes a tube disposed between said receiver and said inlet of said bore.

17. The arrangement of claim 11 wherein,
a vent channel is formed within said housing, said vent channel having a vent opening at said tip end.

18. A method of forming an ear piece shell which includes an outlet bore of a hearing aid device comprising the steps of
selecting a geometry of said outlet bore to produce a preselected frequency response of sound passing therethrough;
forming said ear piece shell which is arranged and designed for insertion in an ear canal, said shell having a tip adapted to face an ear drum when said shell is inserted into said ear canal, with said outlet bore extending inwardly from said tip and having an outlet at said tip and an inlet;
positioning a receiver within said ear piece shell; and
providing a coupler between said receiver and said inlet.

19. The method of claim 18 wherein,
said forming step uses a rapid prototyping process.

20. The method of claim 18 further including the step of forming a vent channel within said shell, said vent channel having an opening at said tip.

21. The method of claim 19 wherein,
said coupler includes a tube between said receiver and said inlet.

22. The method of claim 19 wherein,
said coupler includes a gasket between said receiver and said inlet.

23. The method of claim 19 wherein,
said geometry of said outlet bore is selected to have a length which affects said preselected frequency response.

24. The method of claim 23 wherein,
said geometry of said outlet bore is characterized by diameters at said inlet and said outlet and diameters between said inlet and said outlet which are variable parameters to produce said preselected frequency response.

25. The method of claim 24 wherein,
said length of said bore is selected to produce said preselected frequency response.

26. A hearing aid arrangement comprising,
a housing arranged and designed for insertion in an ear canal, said housing having a tip adapted to face an ear drum when said housing is inserted into said ear canal;
a receiver carried within said housing and spaced inwardly from said tip; and
a bore formed in said housing and positioned between said receiver and said tip, said bore having an outlet at said tip and an inlet, wherein,
said receiver is directly coupled to said inlet, whereby a sound path is created from said receiver via said bore toward said ear drum.
